(19) United States
(12) Patent Application Publication
(10) Pub. No.: US 2026/0109423 A1
(43) Pub. Date: Apr. 23, 2026

(54) COLLAPSIBLE BICYCLE

(71) Applicant: Mark L. Groendal, Grandville, MI (US)

(72) Inventor: Mark L. Groendal, Grandville, MI (US)

(21) Appl. No.: 19/375,976

(22) Filed: Oct. 31, 2025

Related U.S. Application Data
(63) Continuation-in-part of application No. 17/654,066, filed on Mar. 8, 2022.
(60) Provisional application No. 63/158,212, filed on Mar. 8, 2021.
(60) Provisional application No. 63/190,935, filed on May 20, 2021.

(51) Int. Cl. B62K 15/00

(52) U.S. Cl. CPC B62K 15/006

(57) ABSTRACT

A bicycle frame with a front frame having top tube, down tube, and head tube connected together. A rear frame includes spaced-apart seat stays and chain stays with a bottom bracket shell, where rear ends connect to a rear drop out and front ends connect to the bottom bracket shell. A seat tube between front and rear frames has an upper tube connected to the top tube and a lower tube connected to the seat stays and bottom bracket shell. The upper and lower tubes rotate selectively relative to each other. A locking coupler secures the tubes together, featuring a male ball portion with spherical geometry and a female receptacle formed by a clamp bracket with opposed portions separated by a split opening. A cam lever provides clamping force to draw the clamp bracket portions together, securing the male ball portion within the female receptacle.

### CROSS-REFERENCE TO RELATED APPLICATIONS

This application is a continuation-in-part of pending U.S. patent application Ser. No. 17/654,066, filed Mar. 8, 2022, which claims priority to provisional patent application Ser. No. 63/158,212, filed Mar. 8, 2021, and 63/190,935, filed May 20, 2021. The entire contents of each of the above-referenced applications are hereby incorporated by reference.

### BACKGROUND

### 1. Field of the Invention

The present disclosure relates to bicycles, and more particularly to a bicycle that can be collapsed or folded for ease of transportation through a snap-fit connection system with a ball-shaped engagement feature and cam lever mechanism.

### 2. Description of the Prior Art

Bicycles are one of the oldest and most economical means of transportation. Although traditional bicycles are relatively lightweight, they cannot be easily stored or transported due to their bulkiness and size. When bicycles are carried, shipped, or transported over long distances, freight charges often represent a high percentage of the relocation costs. Additionally, consumers face storage space limitations in homes and apartments, while commuters encounter difficulties transporting bicycles on public transportation or in vehicles.

Folding bicycles have been developed to address some of these challenges by providing frames that can be collapsed to reduce their overall dimensions. However, conventional folding bicycle designs often suffer from several drawbacks. The folding mechanisms tend to be complex in construction, making them expensive to manufacture and vulnerable to becoming loosened over time. Many existing folding systems require tools for operation, which reduces convenience for users who need to fold and unfold their bicycles frequently. Furthermore, the structural integrity of folding connections can be compromised, as the joints may not provide adequate strength and stability during riding.

The connection systems used in folding bicycles typically involve multiple components and intricate assembly procedures that can be time-consuming and difficult for users to operate. Some designs rely on threaded fasteners or complex locking mechanisms that may loosen with repeated use, potentially creating safety concerns. Additionally, many folding bicycle frames do not achieve a sufficiently compact folded configuration to provide meaningful advantages for storage and transportation.

There remains a need for improved folding bicycle frame designs that can provide secure, reliable connections while enabling quick and easy folding operations without the use of tools. Such improvements would benefit both manufacturers seeking to reduce shipping costs and consumers desiring convenient storage and transportation solutions.

### SUMMARY

According to an aspect of the present disclosure, a bicycle frame is provided. The bicycle frame comprises a front frame having a top tube, a down tube, and a head tube, the top tube being attached to the head tube, and the down tube being positioned below the top tube and further being attached to the head tube. The bicycle frame further comprises a rear frame having a pair of spaced-apart seat stays, a pair of spaced-apart chain stays, and a bottom bracket shell, each of the seat stays and the chain stays having a rear end and a front end, the rear ends of the seat stays and the rear ends of the chain stays being connected to a rear drop out, the front end of each chain stay being connected to the bottom bracket shell, and the down tube being releasably connected to the bottom bracket shell. The bicycle frame additionally comprises a seat tube arranged between the front frame and the rear frame and coupled to the front frame and the rear frame, the seat tube having an upper tube and a lower tube, the upper tube and the lower tube being selectively rotatable with respect to one another, the upper tube being connected to the top tube, the lower tube being connected to the front end of the seat stays, and the bottom bracket shell being connected to the lower tube. The bicycle frame includes a locking coupler for selectively securing the upper tube of the seat tube to the lower tube of the seat tube to thereby restrict rotation therebetween, the locking coupler having a first male coupling and a first female coupling, the first male coupling including a first male ball portion having a spherical geometry, and the first female coupling including a first female receptacle portion configured to receive the first male ball portion. The locking coupler may further comprise a second male coupling having a second male ball portion positioned opposite the first male coupling and a second female coupling having a second female receptacle portion configured to receive the second male ball portion. The first female coupling being formed by a clamp bracket that includes a first opposed clamp bracket portion and a second opposed clamp bracket portion, the clamp bracket defining a split opening that extends longitudinally through the clamp bracket, separating the first opposed clamp bracket portion from the second opposed clamp bracket portion. The bicycle frame further includes a cam lever mechanism operably connected to the clamp bracket and configured to provide clamping force to draw the first opposed clamp bracket portion and the second opposed clamp bracket portion toward one another to secure the first male ball portion within the first female receptacle portion. The bicycle frame is adapted to be configured in a first position or a second position, in the first position the front frame is positioned forwardly of the seat tube, and in the second position the front frame is rotated rearwardly of the seat tube, wherein the bicycle frame is moved from the first position to the second position by disconnecting the down tube from the bottom bracket shell and rotating the upper tube of the seat tube with respect to the lower tube of the seat tube.

According to other aspects of the present disclosure, the bicycle frame may include one or more of the following features. The male ball portion may include a male leading portion and a male seated portion, the male leading portion having a first width and the male seated portion having a second width that is less than the first width. The female receptacle portion may include a female opening portion and a female seated portion, the female opening portion having a first width and the female seated portion having a second width that is greater than the first width. The cam lever mechanism may comprise a lever arm and a cam bolt, the lever arm being rotatable about a pivot axis to provide mechanical advantage for drawing the first opposed clamp bracket portion and the second opposed clamp bracket portion together. The cam bolt may extend through the clamp bracket and be coupled to the lever arm at one end and to an anchoring member at an opposite end. The clamp bracket may include at least one reinforcement rib extending along an exterior surface of the clamp bracket to provide structural rigidity and prevent deformation under load. The reinforcement rib may be positioned to resist bending forces applied to the clamp bracket during operation of the bicycle frame. The male coupling and the female coupling may be manufactured from 7075 aluminum. The male coupling and the female coupling may be secured to the seat tube through adhesive bonding. The down tube may include a frame engagement section including a transverse hole, and the bottom bracket shell may include a stem having a pair of spaced-apart flanges, each of the flanges having a through hole which is aligned with one another and oriented axially with the transverse hole of the frame engagement section, wherein the down tube and the bottom bracket shell may be connected to one another by inserting the frame engagement section between the flanges so that the transverse hole aligns with both of the through holes, and then inserting a locking pin through the through holes and the transverse hole. The locking pin may be a clevis pin.

According to another aspect of the present disclosure, a locking coupler for a bicycle frame is provided. The locking coupler comprises a male coupling including a male ball portion having a spherical geometry. The locking coupler further comprises a female coupling including a female receptacle portion configured to receive the male ball portion, the female coupling being formed by a clamp bracket that includes a first opposed clamp bracket portion and a second opposed clamp bracket portion, the clamp bracket defining a split opening that extends longitudinally through the clamp bracket, separating the first opposed clamp bracket portion from the second opposed clamp bracket portion, wherein the split opening allows the first opposed clamp bracket portion and the second opposed clamp bracket portion to flex outwardly to accommodate the male ball portion during engagement. The locking coupler additionally comprises a cam lever mechanism operably connected to the clamp bracket and configured to provide clamping force to draw the first opposed clamp bracket portion and the second opposed clamp bracket portion toward one another to secure the male ball portion within the female receptacle portion.

According to other aspects of the present disclosure, the locking coupler may include one or more of the following features. The male ball portion may include a male leading portion and a male seated portion, the male leading portion having a first width and the male seated portion having a second width that is less than the first width. The female receptacle portion may include a female opening portion and a female seated portion, the female opening portion having a first width and the female seated portion having a second width that is greater than the first width. The cam lever mechanism may comprise a lever arm and a cam bolt, the lever arm being rotatable about a pivot axis to provide mechanical advantage for drawing the first opposed clamp bracket portion and the second opposed clamp bracket portion together. The cam bolt may extend through the clamp bracket and be coupled to the lever arm at one end and to an anchoring member at an opposite end.

According to another aspect of the present disclosure, a method of folding a bicycle frame is provided. The method comprises providing a bicycle frame having a front frame, a rear frame, and a seat tube arranged between the front frame and the rear frame, the seat tube having an upper tube and a lower tube that are selectively rotatable with respect to one another, the upper tube and the lower tube being connected by a locking coupler having a male coupling with a male ball portion and a female coupling with a female receptacle portion formed by a clamp bracket with a split opening. The method further comprises disconnecting a down tube of the front frame from a bottom bracket shell of the rear frame. The method additionally comprises releasing a cam lever mechanism of the locking coupler to allow the upper tube to rotate relative to the lower tube. The method further comprises rotating the upper tube relative to the lower tube to move the front frame from a first position where the front frame is positioned forwardly of the seat tube to a second position where the front frame is rotated rearwardly of the seat tube.

According to other aspects of the present disclosure, the method may include one or more of the following features. The step of disconnecting the down tube from the bottom bracket shell may comprise removing a locking pin that extends through a frame engagement section of the down tube and a stem of the bottom bracket shell. The locking pin may be a clevis pin. The step of releasing the cam lever mechanism may comprise rotating a lever arm from a clamped position to a released position to allow the first opposed clamp bracket portion and the second opposed clamp bracket portion of the clamp bracket to separate and permit the male ball portion to disengage from the female receptacle portion.

For a more complete understanding, reference is made to the following detailed description and accompanying drawings. In the drawings, like reference characters refer to like parts throughout the views in which:

### BRIEF DESCRIPTION OF THE DRAWINGS

FIG. 1 illustrates a side view of a collapsible bicycle having a frame, in accordance with an embodiment of the disclosure;

FIG. 2 illustrates a front perspective view of a portion of the bicycle frame showing a connection between a down tube and a head tube, in accordance with an embodiment of the disclosure;

FIG. 3 illustrates an exploded perspective view of a connection system for the bicycle frame, in accordance with an embodiment of the disclosure;

FIG. 4 illustrates an exploded perspective view of a connection assembly for the bicycle frame, in accordance with an embodiment of the disclosure;

FIG. 5 illustrates an isometric view of a connector for the bicycle frame, in accordance with an embodiment of the disclosure;

FIG. 6 illustrates a side view of the bicycle frame showing a connection system between a front frame and a rear frame, in accordance with an embodiment of the disclosure;

FIG. 7 illustrates an enlarged view of a seat tube having a locking coupler with tongue members, in accordance with an embodiment of the disclosure;

FIG. 8 illustrates a perspective view of a locking coupler integrated with a seat post, in accordance with an embodiment of the disclosure;

FIG. 9 illustrates an isometric view of a connection assembly for the bicycle frame seat tube showing engagement between an upper tube and a lower tube, in accordance with an embodiment of the disclosure;

FIG. 10 illustrates an isometric view of the connection assembly for the bicycle frame seat tube of FIG. 9, in accordance with an embodiment of the disclosure;

FIG. 11 illustrates an isometric view of the connection assembly for the bicycle frame seat tube of FIG. 9, in accordance with an embodiment of the disclosure;

FIG. 12 illustrates a partial isometric view of a locking coupler for the bicycle frame seat tube connection system, in accordance with an embodiment of the disclosure;

FIG. 13 illustrates an isometric view of the locking coupler for the bicycle frame seat tube connection system of FIG. 12, in accordance with an embodiment of the disclosure;

FIG. 14 illustrates an isometric view of the locking coupler for the bicycle frame seat tube connection system of FIG. 12, in accordance with an embodiment of the disclosure;

FIG. 15 illustrates a cross-sectional view of a female coupling for the bicycle frame seat tube connection system, in accordance with an embodiment of the disclosure;

FIG. 16 illustrates a cross-sectional view of a male coupling for the bicycle frame seat tube connection system, in accordance with an embodiment of the disclosure;

FIG. 17 illustrates an isometric view of a locking coupler for the bicycle frame seat tube connection system having a reinforcement rib, in accordance with an embodiment of the disclosure; and

FIG. 18 illustrates an isometric view of the locking coupler for the bicycle frame seat tube connection system of FIG. 17, in accordance with an embodiment of the disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to collapsible bicycle frame technology that addresses fundamental challenges in bicycle storage, transportation, and shipping. Traditional bicycle frames maintain a fixed geometric configuration that creates substantial bulk during storage and transportation, resulting in increased shipping costs for manufacturers and storage difficulties for consumers.

A collapsible bicycle frame may incorporate a locking coupler system that enables the frame to transition between an extended riding configuration and a compact folded configuration. The locking coupler system may provide a secure connection mechanism that maintains structural integrity during use while allowing tool-free disassembly for folding operations.

The collapsible frame technology may utilize a snap-fit connection system that enables rapid deployment and compact storage. The snap-fit mechanism may allow frame components to engage and disengage without requiring tools or complex assembly procedures. The connection system may provide sufficient clamping force to prevent movement during riding while enabling quick release for folding operations.

The locking coupler system may comprise complementary male and female coupling components that engage through a ball-and-socket type connection. The male coupling component may feature a ball-shaped engagement element, while the female coupling component may include a receptacle configured to receive and secure the ball-shaped element. The female coupling may incorporate a split design that allows the receptacle to flex during engagement and provide clamping action when secured.

A cam lever mechanism may be integrated with the locking coupler system to provide mechanical advantage for securing the connection. The cam lever may operate through rotational movement that draws opposing portions of the female coupling together, creating clamping pressure around the male coupling component. The cam lever mechanism may enable users to achieve proper clamping force through manual operation without requiring additional tools.

The collapsible bicycle frame may enable the front portion of the frame to fold rearward relative to the rear portion, substantially reducing the overall footprint of the bicycle. The folding action may be accomplished by disconnecting specific frame connections and rotating frame segments about pivot points. The folded configuration may reduce the bicycle's storage volume by approximately 50-70% compared to the extended configuration.

The frame components may be manufactured from lightweight materials such as aluminum alloys that provide strength-to-weight ratios suitable for bicycle applications. The connection components may be secured to frame tubes through various attachment methods including adhesive bonding, welding, or mechanical fasteners. Surface treatments such as anodizing may be applied to enhance durability and corrosion resistance.

Based upon the foregoing disclosure, the present disclosure provides a collapsible bicycle frame that offers substantial advantages over traditional fixed-frame designs. The snap-fit locking coupler system enables rapid folding and deployment without tools, making the bicycle more convenient for storage and transportation. The technology reduces shipping costs for manufacturers through decreased packaging volume and provides consumers with enhanced portability for travel and urban storage applications. The secure connection mechanism maintains structural integrity during riding while enabling quick transition to the compact configuration when needed.

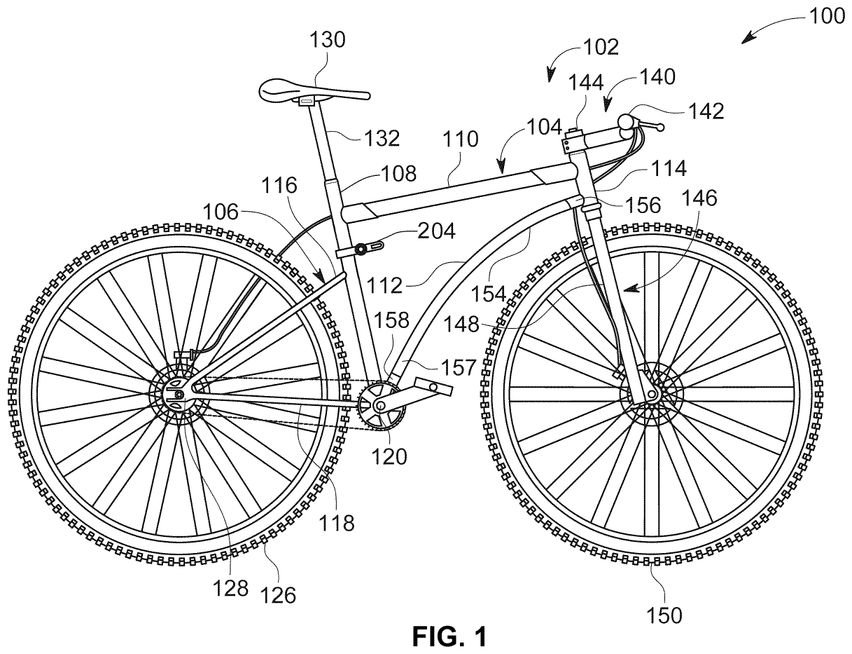

Referring to FIG. 1, there is shown a bicycle 100 having a collapsible frame 102 which may be foldable and collapsible to allow the bicycle 100 to be easily carried, shipped, or transported. The bicycle 100 may be a mountain bike, a road bike, a BMX bike, a trail bike, a time trial bike, a city bike, a casual use bike, an electric bike, or any other style of bike. As shown, the frame 102 may include a front frame 104, a rear frame 106, and a seat tube 108 arranged between the front frame 104 and the rear frame 106 and coupled to the front frame 104 and the rear frame 106. The seat tube 108 may function as a pivot point to fold the front frame 104 and the rear frame 106 toward each other, thereby reducing the overall dimensions of the bicycle 100 when not in use.

The front frame 104 may be adapted to be displaced between a first position and a second position relative to the rear frame 106. In the first position, the front frame 104 may be arranged forwardly of the seat tube 108 and may allow the bicycle 100 to be ridden by a user. In the second position, the front frame 104 may be arranged rearwardly of the seat tube 108 such that the front frame 104 and the rear frame 106 may be folded toward one another to allow storage and transportation of the bicycle 100.

The front frame 104 may include a top tube 110, a down tube 112, and a head tube 114. The top tube 110 may be attached to the head tube 114, and the down tube 112 may be positioned below the top tube 110 and may be further attached to the head tube 114. The rear frame 106 may include a pair of spaced-apart seat stays 116 and a pair of spaced-apart chain stays 118. The rear frame 106 may also include a bottom bracket shell 120 arranged at a lower end of the seat tube 108 and connected to the seat tube 108. Each of the seat stays 116 and the chain stays 118 may have a rear end and a front end, with the rear ends of the seat stays 116 and the chain stays 118 being connected to a rear drop out 128 that may engage an axle on a rear wheel 126. The front end of each chain stay 118 may be connected to the bottom bracket shell 120.

The seat tube 108 may be arranged between the front frame 104 and the rear frame 106 and may be coupled to the front frame 104 and the rear frame 106. The seat tube 108 may have an upper tube and a lower tube, with the upper tube and the lower tube being selectively rotatable with respect to one another. The upper tube may be connected to the top tube 110, and the lower tube may be connected to the front end of the seat stays 116. The bottom bracket shell 120 may be connected to the lower tube of the seat tube 108.

A seat 130 may be mounted on a seat post 132 that may be mounted to the upper end of the seat tube 108, with the seat post 132 fitting downwardly inside a hollow upper portion of the seat tube 108. The bicycle 100 may include a handlebar assembly 140 having a handlebar 142 and a handlebar mount 144 mounted on an upper end of the head tube 114, with the handlebar mount 144 being rotatably mounted on bearings in an open upper end of the head tube 114. A fork assembly 146 may be provided which may have a pair of spaced-apart forks 148 arranged on each side of a front wheel 150 and connected to the front wheel 150 and a fork steerer tube extending upwardly into the interior of the head tube 114, where the fork steerer tube may operably engage with the handlebar mount 144.

The down tube 112 may be an arcuate down tube extending from the head tube 114 to the bottom bracket shell 120. The down tube 112 may include a down tube front end 154 that may be removably connected to a stem 156 extending rearwardly from the head tube 114. The down tube 112 may also have a down tube rear end 157 that may be connected to a stem 158 mounted to the bottom bracket shell 120 at or near the lower end of the seat tube 108.

The bicycle frame 102 may be adapted to be configured in a first position or a second position. In the first position, the front frame 104 may be positioned forwardly of the seat tube 108, and in the second position, the front frame 104 may be rotated rearwardly of the seat tube 108. The bicycle frame 102 may be moved from the first position to the second position by disconnecting the down tube 112 from the bottom bracket shell 120 and rotating the upper tube of the seat tube 108 with respect to the lower tube of the seat tube 108. This configuration may allow the bicycle 100 to be folded into a more compact form for storage and transportation while maintaining structural integrity during use in the first position.

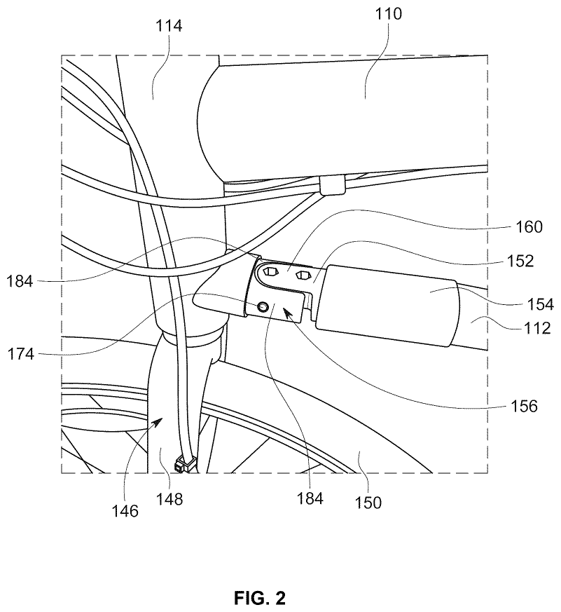

Referring to FIG. 2, the bicycle frame 102 may include a removable connection system that enables the down tube 112 to be disconnected from the head tube 114 to facilitate folding of the bicycle frame 102. The down tube 112 may have a front end 154 that is removably connected to a stem 156 extending rearwardly from the head tube 114. A connector 152 may be provided to establish the removable connection between the down tube 112 and the stem 156. The connector 152 may include a frame engagement section 160 that is configured to interface with the stem 156 and a tube engagement section 162 that is configured to attach to the down tube 112.

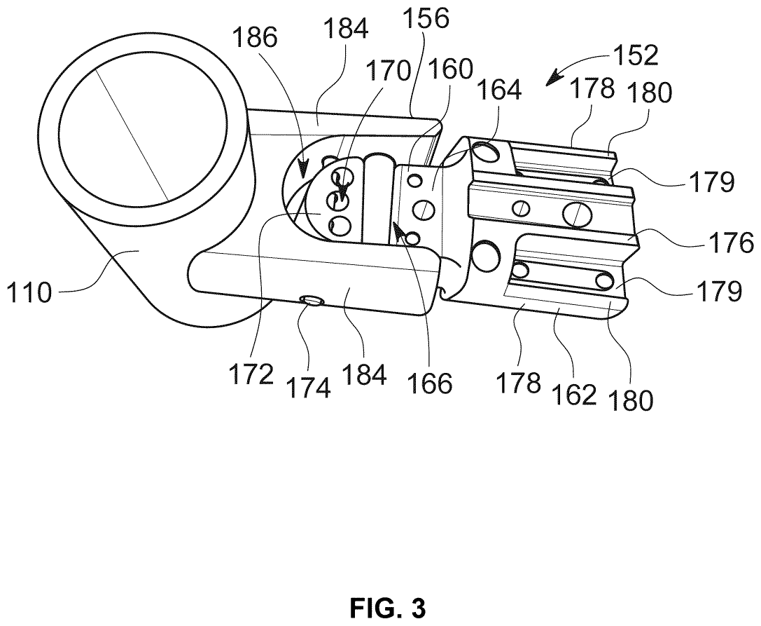

As shown in FIG. 3, the frame engagement section 160 may include a bottom face 164 that has a transverse groove 166 and a transverse hole 170. The transverse groove 166 may be positioned on the bottom face 164 to receive a pin from the stem 156 during assembly. The transverse hole 170 may extend in a lateral direction and may be arranged proximate to a connector front end 172 relative to the transverse groove 166. The transverse hole 170 may facilitate engagement of the connector 152 with the stem 156 through a locking pin 174.

With continued reference to FIG. 3, the tube engagement section 162 may have a cross-shaped configuration that includes a vertical portion 176 with arms 178 extending from opposite sides. The arms 178 may include outwardly extending legs 179 and vertical flanges 180 that provide structural support and prevent rotation when the tube engagement section 162 is inserted into the down tube 112. The tube engagement section 162 may also include screw holes 182 that facilitate coupling of the tube engagement section 162 with the down tube 112 via fasteners.

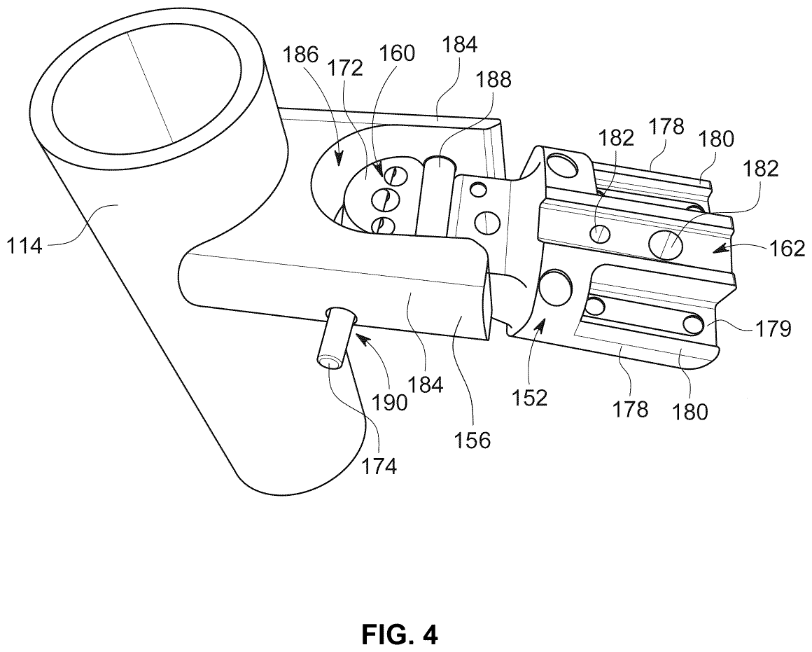

As illustrated in FIG. 4, the stem 156 may include a pair of spaced-apart flanges 184 extending rearwardly from the head tube 114. The flanges 184 may define a gap 186 therebetween that is dimensioned to receive the frame engagement section 160. The stem 156 may also include a pin 188 that is connected to the flanges 184 and extends laterally between the flanges 184. The flanges 184 may define through holes 190 that extend in the lateral direction and are aligned with each other. The through holes 190 may be positioned between the pin 188 and the head tube 114 and may be configured to receive the locking pin 174.

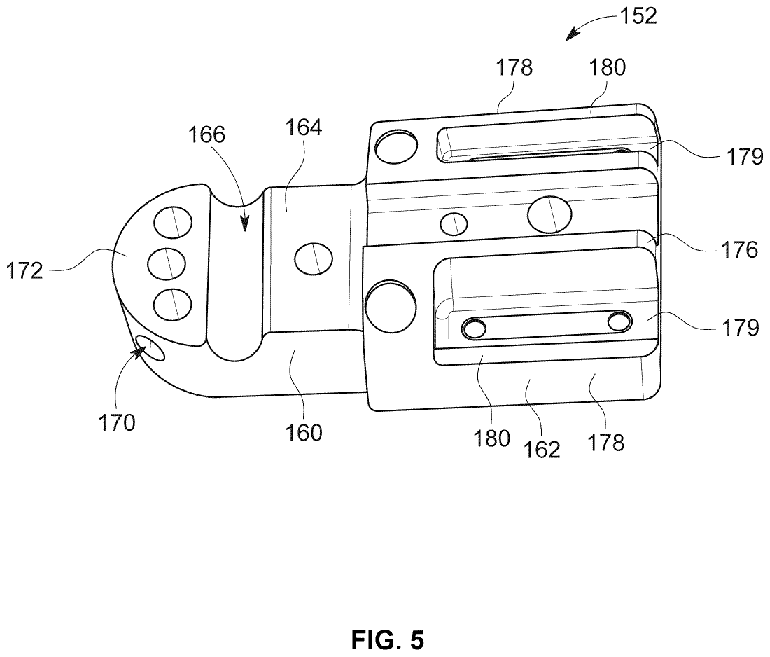

Referring to FIG. 5, the connector 152 may be configured such that the transverse groove 166 is arranged between the tube engagement section 162 and the transverse hole 170. During assembly, the tube engagement section 162 may be inserted inside the down tube 112 and attached through the screw holes 182. The frame engagement section 160 may then be positioned inside the gap 186 such that the pin 188 is received within the transverse groove 166 and the transverse hole 170 aligns with the through holes 190 of the flanges 184. The locking pin 174 may then be inserted through the through holes 190 and the transverse hole 170 to secure the connection between the frame engagement section 160 and the stem 156.

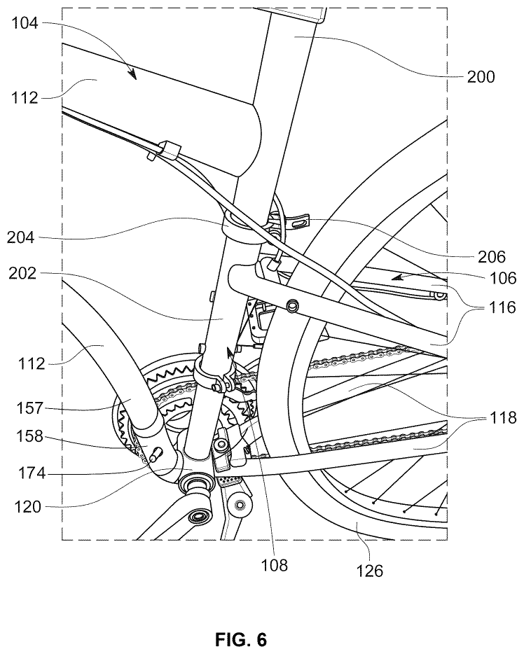

As shown in FIG. 6, the down tube 112 may also have a rear end 157 that is releasably connected to the stem 158 at the bottom bracket shell 120. The connection at the rear end 157 may utilize a similar connector system with a locking pin 174 that extends through aligned holes to provide a removable connection. The locking pin 174 may be a clevis pin that includes a flared end and a through hole for receiving a cotter pin, or alternatively may be a clevis pin having a recessed spring-loaded locking ball mechanism.

With continued reference to FIG. 6, a locking clip 204 may be positioned at the interface between the upper tube 200 and the lower tube 202 of the seat tube 108. The locking clip 204 may include a crank lock 206 that is adapted to move between a lock position and an unlock position. In the lock position, the crank lock 206 may secure the locking clip 204 with the seat tube 108 to prevent rotation between the upper tube 200 and the lower tube 202. In the unlock position, the crank lock 206 may allow the locking clip 204 to slide relative to the seat tube 108, thereby enabling rotation of the upper tube 200 relative to the lower tube 202.

The removable connection system may enable the bicycle frame 102 to be folded by first removing the locking pin 174 from the connections at both the front end 154 and the rear end 157 of the down tube 112. The crank lock 206 may then be moved to the unlock position to allow rotation of the upper tube 200 relative to the lower tube 202, thereby enabling the front frame 104 to be rotated rearwardly relative to the seat tube 108 for compact storage and transportation.

Referring to FIG. 6, the seat tube 108 may comprise an upper tube 200 and a lower tube 202 that are configured to be selectively rotatable with respect to one another. A locking clip 204 may be positioned at an interface between the upper tube 200 and the lower tube 202. The locking clip 204 may include a crank lock 206 that is adapted to move between a lock position and an unlock position. In the lock position, the crank lock 206 may secure the locking clip 204 with the seat tube 108 and prevent sliding of the locking clip 204 on the seat tube 108, thereby restricting rotation between the upper tube 200 and the lower tube 202. In the unlock position of the crank lock 206, the locking clip 204 may slide relative to the seat tube 108, allowing the upper tube 200 to rotate relative to the lower tube 202.

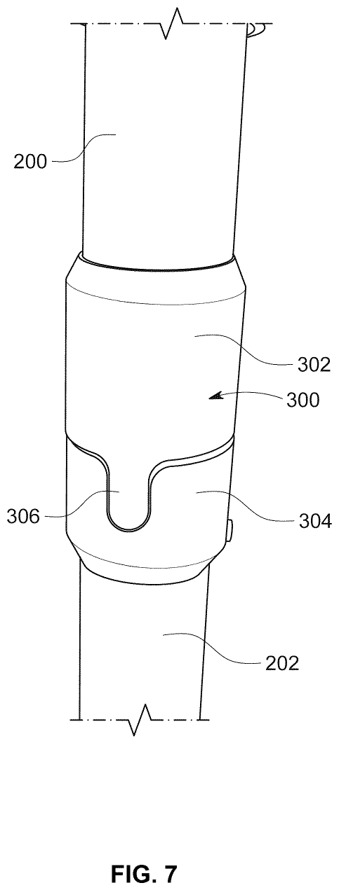

As shown in FIG. 7, a locking coupler 300 may be used to restrict rotation of the upper tube 200 relative to the lower tube 202. The locking coupler 300 may include a male coupling 302 attached to the upper tube 200 and a female coupling 304 attached to the lower tube 202. The male coupling 302 may have a plurality of tongue members 306 extending in a longitudinal direction and away from the upper tube 200. The female coupling 304 may have a plurality of grooves 308 extending in the longitudinal direction. In an engagement of the male coupling 302 and the female coupling 304, the tongue members 306 may be arranged inside the grooves 308 to prevent rotation of the upper tube 200 relative to the lower tube 202.

To enable rotation of the upper tube 200 relative to the lower tube 202, the tongue members 306 may be disengaged from the grooves 308. The male coupling 302 may be moved upwardly toward a seat post in a longitudinal direction relative to the upper tube 200, and the female coupling 304 may be moved downwardly toward a bottom bracket shell relative to the lower tube 202. The tongue members 306 and the grooves 308 may be dimensioned such that the width of each tongue member 306 may be approximately equal to the distance on the female coupling 304 between the grooves 308, providing a sinusoidal geometry whereby the male coupling 302 and the female coupling 304 have complementary shapes that mate with one another.

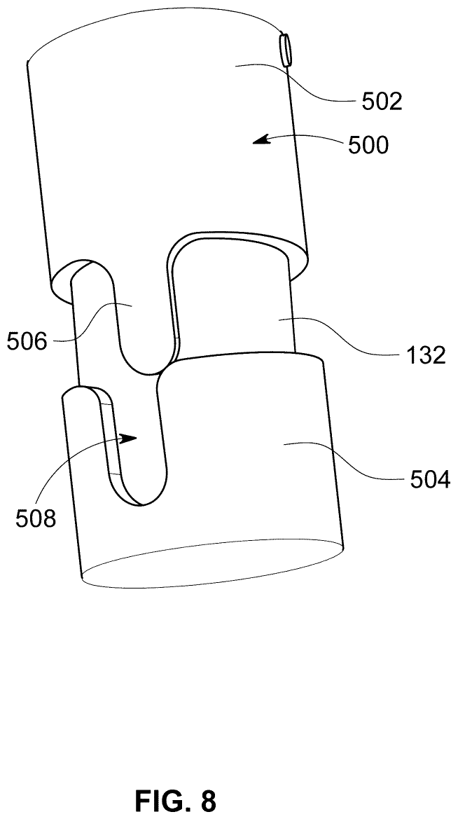

Referring to FIG. 8, an alternative locking coupler 500 may be integrated with the seat post 132. The locking coupler 500 may comprise a male coupling 502 and a female coupling 504 that are configured to engage with one another to restrict rotational movement. The male coupling 502 may include a plurality of tongue members 506 that extend in a longitudinal direction. The female coupling 504 may include a plurality of grooves 508 that extend in the longitudinal direction and are dimensioned to receive the tongue members 506. The male coupling 502 and the female coupling 504 may both be integrally formed with and concentrically surround the seat post 132. When the tongue members 506 are arranged inside the grooves 508, the male coupling 502 and the female coupling 504 may be engaged, thereby preventing rotation therebetween. The locking coupler 500 may provide a mechanism for selectively restricting rotational movement about the seat post 132 through the engagement and disengagement of the complementary tongue members 506 and grooves 508.

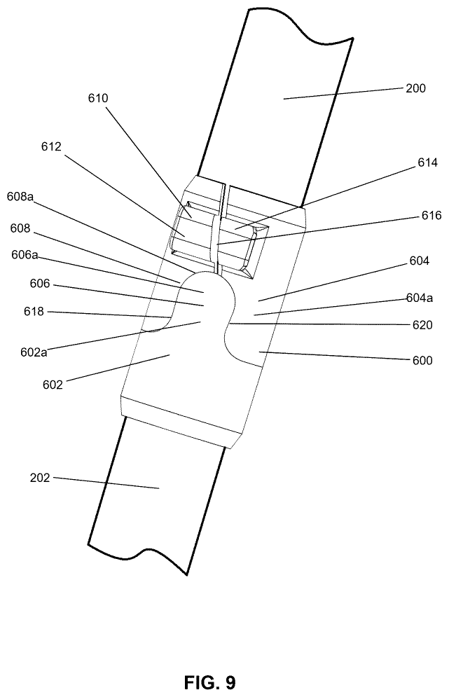

Referring to FIG. 9, the seat tube 108 may include a locking coupler 600 for selectively securing the upper tube 200 to the lower tube 202 to thereby restrict rotation therebetween. The locking coupler 600 may have a first male coupling 602a and a first female coupling 604a, and a second male coupling 602b and a second female coupling 604b positioned opposite the first male coupling 602a. The first male coupling 602a may include a first male ball portion 606a having a spherical geometry, and the second male coupling 602b may include a second male ball portion 606b. The first female coupling 604a may include a first female receptacle portion 608a configured to receive the first male ball portion 606a, and the second female coupling 604b may include a second female receptacle portion 608b configured to receive the second male ball portion 606b.

The first male coupling 602a and first female coupling 604a may form a snap-fit connection characterized by elastic deformation of the clamp bracket 610 during engagement of the first male ball portion 606a with the first female receptacle portion 608a. The first female coupling 604a may be formed by the clamp bracket 610 that includes a first opposed clamp bracket portion 612 and a second opposed clamp bracket portion 614. The clamp bracket 610 may define a split opening 616 that extends longitudinally through the clamp bracket 610, separating the first opposed clamp bracket portion 612 from the second opposed clamp bracket portion 614. The split opening 616 may allow the first opposed clamp bracket portion 612 and the second opposed clamp bracket portion 614 to flex outwardly to accommodate the first male ball portion 606a during engagement.

The second male coupling 602b and second female coupling 604b may form a slip-fit connection having complementary straight sidewalls of uniform width. The second female coupling 604b may comprise a straight slip-fit receptacle 608b having cylindrical sidewalls that mate with corresponding straight sidewalls on the second male ball portion 606b. This slip-fit connection may provide smooth insertion and removal without elastic deformation, differing from the snap-fit connection by providing linear engagement without the retentive characteristics of the flexing clamp bracket 610.

The female coupling 604 may be formed by a clamp bracket 610 that includes a first opposed clamp bracket portion 612 and a second opposed clamp bracket portion 614. The clamp bracket 610 may define a split opening 616 that extends longitudinally through the clamp bracket 610, separating the first opposed clamp bracket portion 612 from the second opposed clamp bracket portion 614. The split opening 616 may allow the first opposed clamp bracket portion 612 and the second opposed clamp bracket portion 614 to flex outwardly to accommodate the male ball portion 606 during engagement.

With continued reference to FIG. 9, the first female receptacle portion 608a may be positioned within the clamp bracket 610 and may be dimensioned to receive the first male ball portion 606a. The first female receptacle portion 608a may include a female receptacle first side 618 and a female receptacle second side 620. When the first male ball portion 606a is inserted into the first female receptacle portion 608a, the split opening 616 may permit the clamp bracket 610 to expand temporarily through elastic deformation, increasing the distance between the female receptacle first side 618 and the female receptacle second side 620. The second female receptacle portion 608b may maintain constant dimensions during engagement, providing a slip-fit interface with the second male ball portion 606b.

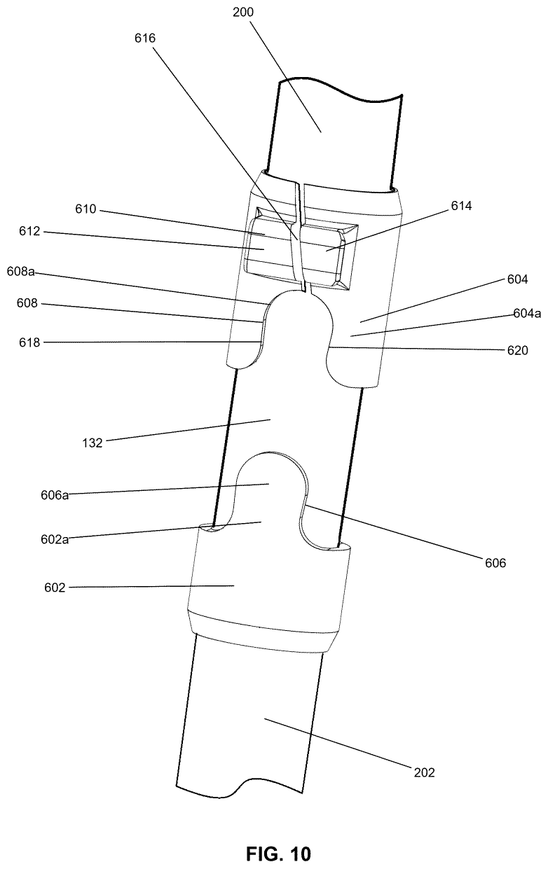

As shown in FIG. 10, once the male ball portion 606 is fully seated within the female receptacle portion 608, the first opposed clamp bracket portion 612 and the second opposed clamp bracket portion 614 may be drawn together to draw the female receptacle first side 618 and the female receptacle second side 620 toward one another, thereby securing the connection. The spherical geometry of the male ball portion 606 may enable the male coupling 602 to snap into the female coupling 604 and may provide a secure connection when the female coupling 604 clamps around the male ball portion 606.

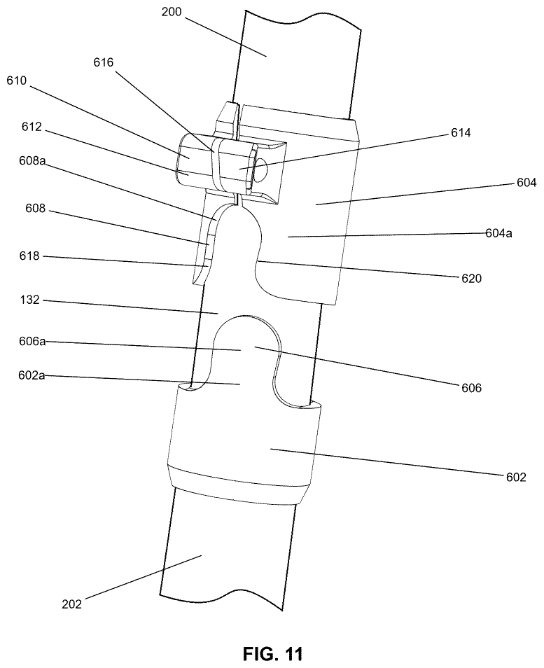

Referring to FIG. 11, the locking coupler 600 may provide a snap-fit engagement mechanism that enables tool-free assembly and disassembly of the bicycle frame components. The male coupling 602 may be attached to the lower tube 202, while the female coupling 604 may be attached to the upper tube 200. In some cases, a cam lever mechanism may be operably connected to the clamp bracket 610 and may be configured to provide clamping force to draw the first opposed clamp bracket portion 612 and the second opposed clamp bracket portion 614 toward one another to secure the male ball portion 606 within the female receptacle portion 608.

The split opening 616 may facilitate the engagement process by allowing the clamp bracket 610 to temporarily deform as the male ball portion 606 passes through the female receptacle portion 608. The spherical geometry of the male ball portion 606 may provide self-centering alignment during engagement, while the split configuration in the clamp bracket 610 may create uniform clamping pressure around the male ball portion 606 when the connection is secured.

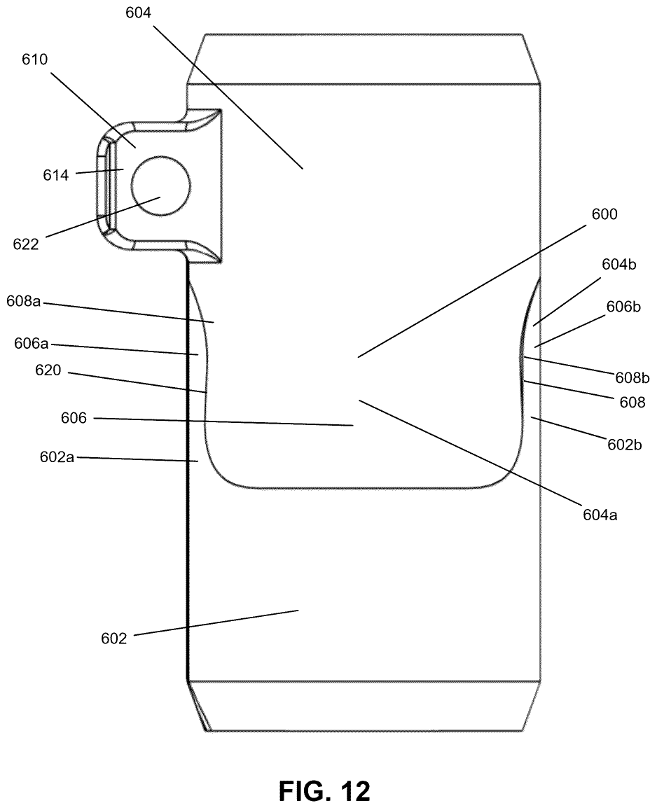

Referring to FIG. 12, the locking coupler 600 may include a cam bolt receptacle 622 positioned within and extending through the clamp bracket 610. The cam bolt receptacle 622 may be configured to receive a cam lever mechanism that provides clamping force to secure the connection between the male coupling 602 and the female coupling 604. The cam bolt receptacle 622 may extend through both the first opposed clamp bracket portion 612 and the second opposed clamp bracket portion 614, providing a pathway for the mechanical components that generate the clamping action.

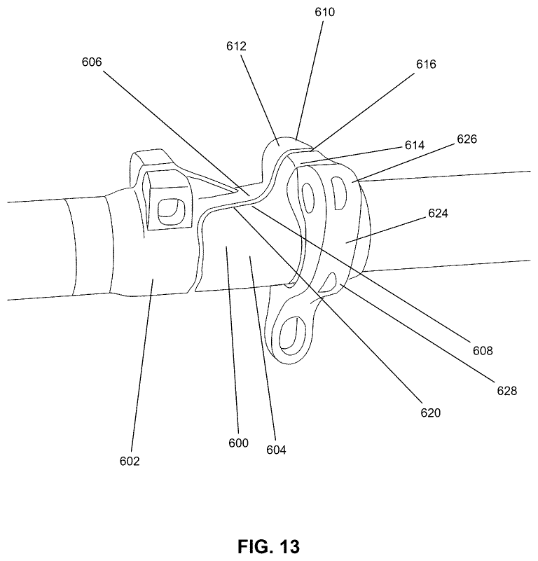

As shown in FIG. 13, a cam lever 624 may be mounted to the clamp bracket 610 and operably connected to a cam lever mechanism 626. The cam lever 624 may include a lever arm 628 that extends outwardly from the clamp bracket 610. The cam lever mechanism 626 may be configured to provide clamping force when the lever arm 628 is rotated, drawing the first opposed clamp bracket portion 612 and the second opposed clamp bracket portion 614 toward one another to secure the male ball portion 606 within the female receptacle portion 608.

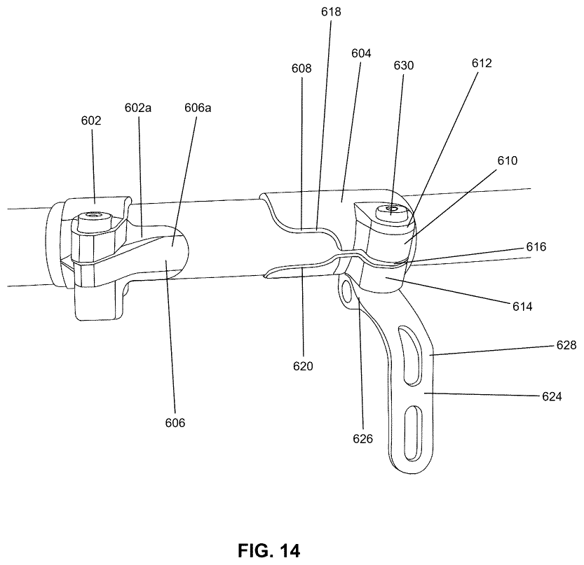

With continued reference to FIG. 13 and FIG. 14, the cam lever mechanism 626 may comprise the lever arm 628 and a cam bolt 630. The lever arm 628 may be rotatable about a pivot axis to provide mechanical advantage for drawing the first opposed clamp bracket portion 612 and the second opposed clamp bracket portion 614 together. The rotational movement of the lever arm 628 may create an eccentric cam action that amplifies the applied force, enabling the user to generate sufficient clamping pressure with minimal manual effort.

As further shown in FIG. 14, the cam bolt 630 may extend through the clamp bracket 610 and may be coupled to the lever arm 628 at one end and to an anchoring member at an opposite end. The cam bolt 630 may pass through the cam bolt receptacle 622, providing the mechanical linkage between the lever arm 628 and the clamp bracket 610. When the lever arm 628 is rotated toward a clamped position, the cam bolt 630 may create axial tension that draws the first opposed clamp bracket portion 612 and the second opposed clamp bracket portion 614 toward each other, thereby reducing the distance between the female receptacle first side 618 and the female receptacle second side 620 to securely clamp the male ball portion 606.

The cam lever mechanism 626 may operate in a manner similar to conventional quick-release mechanisms used in bicycle applications. When the lever arm 628 is in a released position, the cam bolt 630 may allow the first opposed clamp bracket portion 612 and the second opposed clamp bracket portion 614 to separate sufficiently to permit insertion or removal of the male ball portion 606. When the lever arm 628 is rotated to a locked position, the eccentric cam surface may engage an adjacent bearing surface and, due to the offset geometry, may produce a drawing action that axially tensions the cam bolt 630. The mechanical advantage provided by the lever arm 628 may enable the generation of substantial clamping force while maintaining tool-free operation for rapid engagement and disengagement of the connection system.

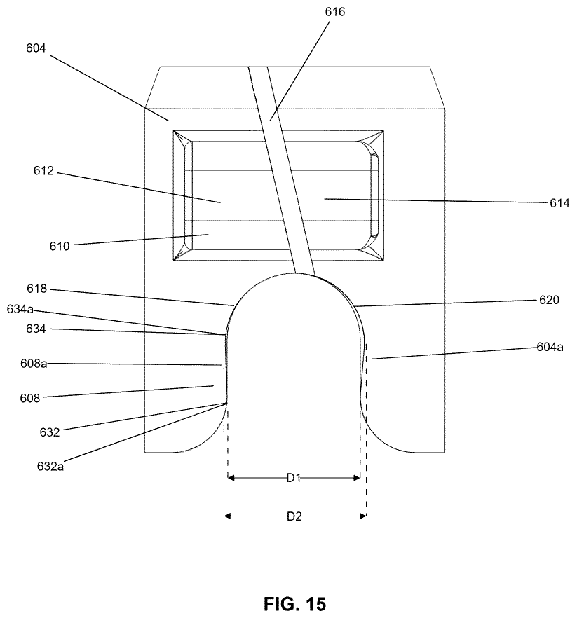

Referring to FIG. 15, the female coupling 604 may include specific geometric features that facilitate the snap-fit engagement with the male ball portion 606. The female receptacle portion 608 may include a female opening portion 632 and a female seated portion 634, each having distinct dimensional characteristics that enable the connection mechanism to function properly. The female opening portion 632 may be positioned at a lower region of the female receptacle portion 608 and may define an entry area through which the male ball portion 606 is inserted during assembly. The female opening portion 632 may have a first width, designated as coupling seated width D1, which represents the narrower dimension of the female receptacle portion 608.

The first female receptacle portion 608a may include specific geometric features that facilitate the snap-fit engagement with the first male ball portion 606a. The first female receptacle portion 608a may include a female opening portion 632a and a female seated portion 634a, each having distinct dimensional characteristics that enable the connection mechanism to function properly. The female opening portion 632a may be positioned at a lower region of the first female receptacle portion 608a and may define an entry area through which the first male ball portion 606a is inserted during assembly. The female opening portion 632a may have a first width, designated as coupling seated width D1, which represents the narrower dimension of the first female receptacle portion 608a. The female seated portion 634a may be positioned above the female opening portion 632a and may define a region where the first male ball portion 606a is fully received and secured when the connection is engaged. The female seated portion 634a may have a second width, designated as coupling opening width D2, which is greater than the first width D1 of the female opening portion 632a. This dimensional relationship may allow the first female receptacle portion 608a to provide a secure seating area for the first male ball portion 606a while maintaining a narrower opening that helps retain the connection.

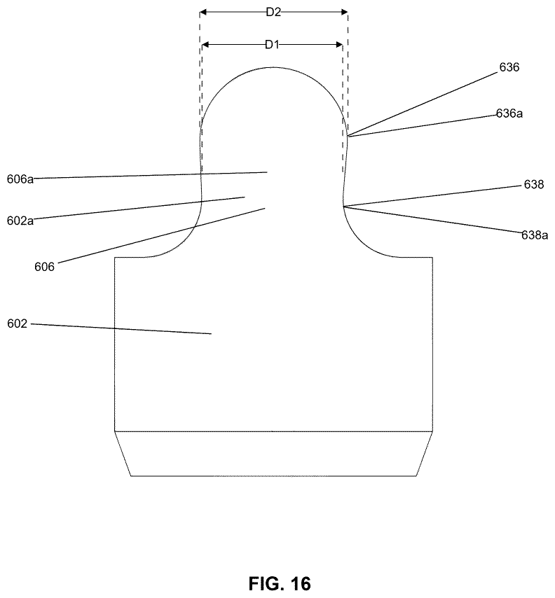

Referring to FIG. 16, the male coupling 602 may include complementary geometric features that correspond to the female coupling 604 configuration. The male ball portion 606 may include a male leading portion 636 and a male seated portion 638, each having specific dimensional characteristics that enable engagement with the female receptacle portion 608. The male leading portion 636 may be positioned at a distal region of the male ball portion 606 and may define an entry area that initially contacts and engages with the female coupling 604 during insertion.

The first male ball portion 606a may include complementary geometric features that correspond to the first female coupling 604a configuration. The first male ball portion 606a may include a male leading portion 636a and a male seated portion 638a, each having specific dimensional characteristics that enable engagement with the first female receptacle portion 608a. The male leading portion 636a may be positioned at a distal region of the first male ball portion 606a and may define an entry area that initially contacts and engages with the first female coupling 604a during insertion. The male leading portion 636a may have a first width, designated as coupling opening width D2, which facilitates initial insertion into the first female coupling 604a. The larger dimension of the male leading portion 636a may force the first female coupling 604a to flex outwardly as the first male ball portion 606a is pushed through the female opening portion 632a. The male seated portion 638a may be positioned at a proximate region of the first male ball portion 606a relative to the male leading portion 636a, and the male seated portion 638a may define a region that is fully received within the first female coupling 604a when the connection is engaged. The male seated portion 638a may have a second width, designated as coupling seated width D1, which is less than the first width D2 of the male leading portion 636a. This dimensional relationship may provide a secure engagement surface once the first male ball portion 606a is fully seated within the first female receptacle portion 608a. The spherical geometry of the first male ball portion 606a, combined with the varying widths of the male leading portion 636a and male seated portion 638a, may enable the first male coupling 602a to snap into the first female coupling 604a and provide a secure connection when the first female coupling 604a clamps around the male seated portion 638a.

The male seated portion 638 may have a second width, designated as coupling seated width D1, which is less than the first width D2 of the male leading portion 636. This dimensional relationship may provide a secure engagement surface once the male ball portion 606 is fully seated within the female receptacle portion 608. The spherical geometry of the male ball portion 606, combined with the varying widths of the male leading portion 636 and male seated portion 638, may enable the male coupling 602 to snap into the female coupling 604 and provide a secure connection when the female coupling 604 clamps around the male seated portion 638.

The dimensional relationships between the male coupling 602 and female coupling 604 may create a snap-fit mechanism where the male leading portion 636 temporarily expands the female opening portion 632 during insertion, and the male seated portion 638 settles into the female seated portion 634 for secure engagement. The split opening 616 in the clamp bracket 610 may allow the necessary flexing of the female coupling 604 to accommodate the varying dimensions of the male ball portion 606 during the engagement process.

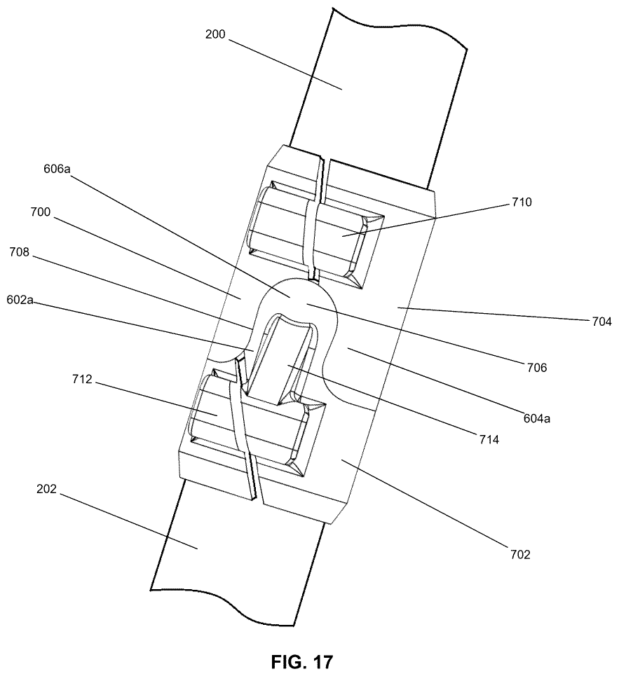

Referring to FIG. 17, a locking coupler 700 may be provided for the bicycle frame seat tube connection system. The locking coupler 700 may comprise a male coupling 702 and a female coupling 704 configured to engage with one another to provide a secure connection between the upper tube 200 and the lower tube 202. The male coupling 702 may be attached to the lower tube 202 and may include a male ball portion 706 having a spherical or ball-shaped geometry. The male ball portion 706 may be configured to be received within the female coupling 704 during assembly of the connection system.

The male coupling 702 may further include a male coupling clamp bracket 712 that secures the male coupling 702 to the lower tube 202. The female coupling 704 may be attached to the upper tube 200 and may include a female receptacle portion 708 dimensioned to receive and engage with the male ball portion 706. The female coupling 704 may include a clamp bracket 710 that surrounds the upper tube 200. The clamp bracket 710 may be configured to provide structural support and clamping functionality for securing the connection between the male coupling 702 and the female coupling 704.

The clamp bracket 710 may include at least one reinforcement rib 714 that extends along an exterior surface of the clamp bracket 710 toward the male ball portion 706. The reinforcement rib 714 may provide additional structural rigidity to the clamp bracket 710, preventing deformation under load and maintaining the integrity of the connection during use. The reinforcement rib 714 may be positioned to resist bending forces that may be applied to the clamp bracket 710 during operation of the bicycle frame.

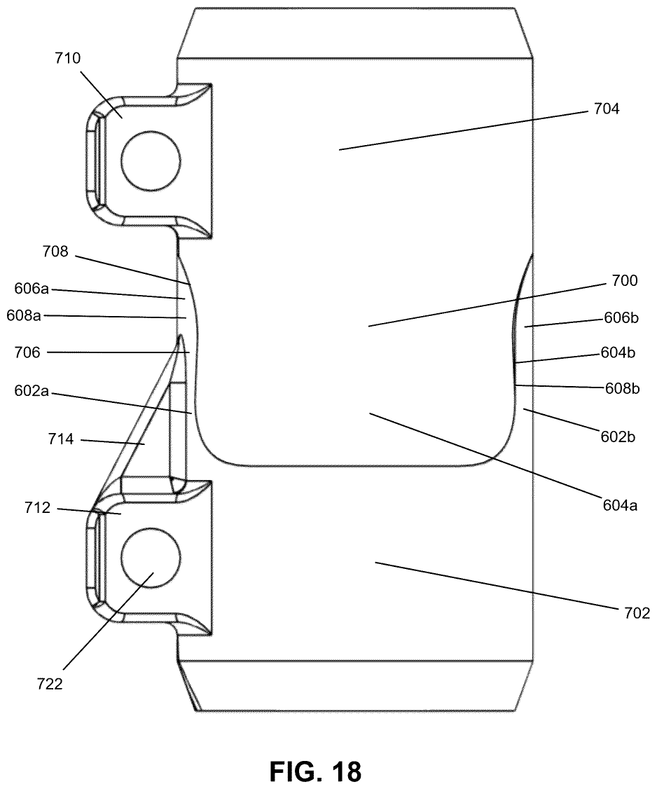

With reference to FIG. 18, the locking coupler 700 may be configured to provide a secure connection between frame components. The male coupling 702 may include the male ball portion 706 having the spherical or ball-shaped geometry, and the male coupling 702 may further include the male coupling clamp bracket 712 that secures the male coupling 702 to a tubular frame member. The female coupling 704 may include the female receptacle portion 708 dimensioned to receive and engage with the male ball portion 706.

The clamp bracket 710 may further include a cam bolt receptacle 722 positioned within and extending through the clamp bracket 710. The cam bolt receptacle 722 may be configured to receive a cam lever mechanism that provides clamping force to secure the connection between the male coupling 702 and the female coupling 704. The reinforcement rib 714 may extend along the exterior surface of the clamp bracket 710 and may be positioned to resist bending forces applied to the clamp bracket 710 during operation of the bicycle frame, thereby maintaining structural integrity of the connection system under various loading conditions.

The male coupling and female coupling may be manufactured from various aluminum alloys to meet different performance and cost requirements. In some cases, the male coupling and the female coupling are manufactured from 7075 aluminum, which provides high strength-to-weight ratios suitable for bicycle frame applications. The 7075 aluminum alloy may offer tensile strength characteristics that enable the connection system to withstand the loads encountered during bicycle operation while maintaining relatively low weight.

Alternative aluminum alloys may be selected based on specific application requirements. The male coupling and female coupling may be manufactured from 6061-T6 aluminum for cost-effective applications where moderate strength requirements allow for material cost optimization. In some cases, 7068 aluminum may be used for enhanced strength approaching steel properties, providing superior load-bearing capabilities for high-performance bicycle applications. The male coupling and female coupling may also be manufactured from 2024 aluminum for aerospace-grade applications where weight reduction and strength characteristics are prioritized.

The connection system components may be secured to the seat tube through various attachment methods. In some cases, the male coupling and the female coupling are secured to the seat tube through adhesive bonding. Adhesive bonding may utilize structural adhesives such as Scotch Weld DP460, which may provide permanent attachment between the connection components and the seat tube. The adhesive bonding method may eliminate the need for mechanical fasteners while distributing loads across the bonded interface.

Alternative attachment methods may include set screws that extend radially through the connection components to engage the seat tube surface. Welding may be employed when material compatibility permits, creating metallurgical bonds between the connection components and the seat tube. Other securing techniques may include brazing for dissimilar metals, mechanical interference fits, or integrated manufacturing where connection features are machined directly into the seat tube.

The cam lever mechanism may be constructed from various materials to optimize performance characteristics. In some cases, the cam lever mechanism may be constructed from stainless steel to provide corrosion resistance and durability. The cam lever mechanism may alternatively be constructed from titanium for applications requiring reduced weight while maintaining strength properties. High-strength polymer materials may be used for the cam lever mechanism in applications where weight reduction is prioritized and load requirements permit polymer construction.

For weight-critical applications, carbon fiber reinforced polymer may be used for non-load-bearing components of the connection system. The carbon fiber reinforced polymer may provide significant weight reduction compared to metallic alternatives while maintaining adequate structural properties for components that do not experience primary structural loads.

The connection components may receive various surface treatments to enhance performance and durability characteristics. Hard coat anodizing may be applied for extreme durability applications, providing a hard, wear-resistant surface layer that extends component service life. Cerakote coating may be applied for corrosion resistance and aesthetic options, offering both protective and decorative surface properties. Powder coating may be used for cost-effective protection, providing corrosion resistance and color options at reduced processing costs. Electroplating with nickel or chrome may be employed to provide corrosion protection and enhanced surface hardness.

The male ball portion may incorporate specialized low-friction coatings to facilitate smoother engagement and disengagement during folding operations. PTFE coatings may be applied to reduce friction between the male ball portion and the female receptacle portion during assembly and disassembly operations. Molybdenum disulfide coatings may alternatively be used to provide low-friction characteristics while maintaining durability under repeated cycling operations.

The connection components may be produced through various manufacturing methods to achieve desired geometries and material properties. Investment casting may be used for complex geometries that would be difficult or expensive to machine from solid stock. The investment casting process may enable the production of intricate internal features and complex external contours while maintaining dimensional accuracy.

Forging may be employed for enhanced grain structure and strength characteristics. The forging process may align material grain structure with component loading directions, potentially improving fatigue resistance and overall strength properties compared to cast or machined alternatives.

Additive manufacturing may be utilized for customized profiles or low-volume production requirements. The additive manufacturing process may enable the production of complex internal geometries and customized external features that would be impractical with conventional manufacturing methods.

Hydroforming may be used for hollow lightweight structures where weight reduction is prioritized. The hydroforming process may enable the production of hollow components with varying wall thicknesses and complex cross-sectional geometries while maintaining structural integrity and reducing overall component weight.

The cam lever system may be implemented with various alternative configurations to provide different operational characteristics and user interfaces. In some cases, a threaded adjustment mechanism may be incorporated into the cam lever system for fine-tuning clamping force. The threaded adjustment mechanism may include a threaded rod or bolt that extends through the cam lever assembly, allowing precise control of the clamping pressure applied to the connection components. The threaded adjustment mechanism may enable users to incrementally increase or decrease the clamping force by rotating a threaded element, providing more precise control than a standard cam lever alone.

In some cases, a ratcheting cam lever may be employed for incremental tightening of the connection system. The ratcheting cam lever may include a ratcheting mechanism that allows the lever to be moved in small incremental steps, with each step providing a predetermined increase in clamping force. The ratcheting mechanism may include a pawl and ratchet wheel configuration that prevents backward movement of the lever once engaged, ensuring that the clamping force is maintained at the desired level. The ratcheting cam lever may allow for more controlled and consistent application of clamping force compared to conventional cam levers.

A dual-cam system with opposing levers may be implemented for enhanced clamping distribution across the connection interface. The dual-cam system may include two cam levers positioned on opposite sides of the clamp bracket, with each cam lever applying clamping force to a different portion of the connection assembly. The opposing levers may work in conjunction to provide more uniform pressure distribution around the circumference of the connection, reducing stress concentrations and improving the overall security of the connection. The dual-cam system may also provide redundancy in the clamping mechanism, ensuring that the connection remains secure even if one cam lever experiences reduced effectiveness.

The lever arm may incorporate various handle configurations to improve user interaction and operational convenience. In some cases, ergonomic grips may be integrated into the lever arm to provide improved comfort and control during operation. The ergonomic grips may include contoured surfaces, textured materials, or cushioned elements that conform to the user's hand and reduce fatigue during repeated use. The ergonomic grips may be particularly beneficial for users who frequently engage and disengage the connection system.

In some cases, folding handles may be incorporated into the lever arm design to reduce the profile of the cam lever when locked. The folding handles may include a hinge mechanism that allows a portion of the lever arm to fold against the main body of the cam lever assembly when not in use. The folding handles may reduce the overall dimensions of the connection system when the bicycle frame is in the riding configuration, minimizing interference with other components and reducing the risk of accidental engagement or damage to the lever.

Quick-release mechanisms similar to bicycle wheel skewers may be integrated into the cam lever system to provide familiar operation for bicycle users. The quick-release mechanisms may include a cam-operated lever with a spring-loaded mechanism that provides tactile feedback when the lever is moved between the open and closed positions. The quick-release mechanisms may incorporate a threaded adjustment nut that allows for fine-tuning of the clamping force while maintaining the quick-release functionality. The quick-release mechanisms may provide a balance between ease of operation and secure clamping force, making the connection system accessible to users with varying levels of mechanical experience.

The male ball portion may be configured with various geometric profiles to optimize engagement characteristics and manufacturing requirements. In some cases, the male ball portion may feature an elliptical shape that provides directional engagement properties. The elliptical configuration may orient the major axis of the ellipse to align with specific directional forces during bicycle operation, thereby enhancing the structural integrity of the connection under load. The elliptical geometry may also facilitate easier insertion and removal during folding operations while maintaining secure engagement when fully seated.

In some cases, the male ball portion may incorporate a truncated spherical profile that reduces manufacturing complexity while maintaining functional performance. The truncated spherical configuration may eliminate portions of the sphere that are not functionally necessary for the engagement mechanism, thereby reducing material requirements and machining time. The truncated profile may maintain the snap-fit engagement characteristics while providing cost-effective production advantages.

The male ball portion may alternatively feature compound curves that provide progressive engagement resistance during assembly. The compound curve geometry may incorporate varying radii along the surface of the male ball portion, creating regions of different curvature that interact with the female receptacle portion during insertion. The progressive engagement resistance may provide tactile feedback to the user, indicating proper seating and engagement of the connection system.

In some cases, the male ball portion may incorporate multiple engagement positions through circumferential ridges or detents positioned around the surface of the male ball portion. The circumferential ridges may be spaced at predetermined intervals to provide discrete engagement positions that correspond to different rotational orientations of the frame components. The detents may create tactile feedback during assembly, providing audible or physical confirmation when the male ball portion reaches each engagement position. The multiple engagement positions may allow for fine adjustment of frame geometry or accommodation of different folding configurations.

The split opening in the clamp bracket may be oriented at various angles relative to the frame centerline to optimize stress distribution and clamping performance. In some cases, the split opening may be positioned diagonally relative to the longitudinal axis of the frame tube, creating a diagonal split configuration. The diagonal split may distribute clamping forces more evenly around the circumference of the male ball portion, reducing stress concentrations that could lead to material fatigue or connection failure. The diagonal orientation may also provide improved resistance to torsional loads applied during bicycle operation.

The clamp bracket may alternatively incorporate multiple splits that create segmented clamping sections around the female receptacle portion. The multiple splits may divide the clamp bracket into three or more segments, each capable of independent flexing during engagement with the male ball portion. The segmented clamping sections may provide more uniform contact pressure around the male ball portion surface, enhancing the security of the connection while reducing localized stress concentrations.

In some cases, the split opening width may be variable along the length of the split opening, creating a tapered opening configuration. The tapered opening may feature a wider dimension at the entry region where the male ball portion initially contacts the female receptacle portion, facilitating easier insertion and initial engagement. The tapered opening may gradually narrow toward the seated region where the male ball portion reaches full engagement, providing progressively tighter contact and more secure final positioning. The variable width configuration may combine the benefits of easy assembly with secure retention, optimizing both user convenience and connection reliability.

Based upon the foregoing disclosure, the present disclosure provides a snap-fit connection system for folding bicycle frames that enables compact storage and transportation through a secure, tool-free folding mechanism. The system surpasses prior art folding mechanisms by providing reliable snap-fit engagement that eliminates the need for tools while maintaining structural integrity during use. The ball-shaped engagement geometry provides self-centering alignment and uniform stress distribution, while the split clamp bracket configuration enables flexible assembly with secure retention. The cam lever mechanism amplifies applied force to achieve necessary clamping pressure while allowing easy release for folding operations, addressing the fundamental challenges of bicycle bulk during shipping and storage while providing convenient operation for end users.

The reinforcement structures of the connection system may be configured in various patterns to provide structural integrity while maintaining weight efficiency. Radial ribs may extend outwardly from a central bore of the clamp bracket, distributing stress loads uniformly across the bracket structure. The radial rib configuration may provide enhanced resistance to torsional forces that occur during bicycle operation. In some cases, helical ribs may follow the circumference of the tubular frame member, creating a spiral reinforcement pattern that provides both axial and rotational strength. The helical rib arrangement may offer improved load distribution compared to straight reinforcement patterns.

Lattice structures may be incorporated into the clamp bracket design to achieve strength-to-weight ratios that exceed conventional solid reinforcement configurations. The lattice structure may comprise intersecting ribs that form a network of triangular or hexagonal openings, reducing material usage while maintaining structural performance. In some cases, the lattice pattern may be optimized through computational analysis to identify the most efficient rib placement for the expected load conditions.

Internal reinforcement features may be integrated into the connection system to enhance durability and operational performance. Threaded inserts may be positioned within the clamp bracket to receive the cam lever mechanism, providing secure mounting points that resist thread wear during repeated operation. The threaded inserts may be manufactured from materials with superior wear resistance compared to the base bracket material. In some cases, integrated bearing surfaces may be incorporated into the connection system to reduce friction and wear during repeated folding cycles. The bearing surfaces may comprise hardened material regions or separate bearing elements that provide smooth relative motion between components.

The connection system may be secured to the seat tube through various attachment methods depending on material compatibility and manufacturing requirements. Welding may be employed for compatible materials, creating a permanent metallurgical bond between the connection components and the seat tube. The welding process may include techniques such as tungsten inert gas welding, metal inert gas welding, or electron beam welding, depending on the specific materials and joint requirements.

Brazing may be utilized for dissimilar metals where direct welding is not feasible due to material incompatibility. The brazing process may employ filler metals with melting points lower than the base materials, creating a strong joint without melting the parent materials. In some cases, mechanical interference fits may provide attachment without requiring thermal joining processes. The interference fit may be achieved through precise dimensional control where the connection component outer diameter exceeds the seat tube inner diameter by a predetermined amount, creating a secure press-fit connection.

Integrated manufacturing may be employed where the connection features are machined directly into the seat tube during the tube manufacturing process. The integrated approach may eliminate separate attachment operations and provide seamless integration between the connection system and the frame structure. In some cases, the ball-shaped engagement feature may be machined as an integral part of the seat tube material rather than being attached as a separate component.

Removable attachment configurations may be achieved through bayonet-style connections that enable quick assembly and disassembly without tools. The bayonet connection may comprise tabs or lugs on the connection component that engage with corresponding slots in the seat tube through a rotational motion. Threaded collars may provide an alternative removable attachment method, where the connection component is secured to the seat tube through threaded engagement that can be tightened or loosened as needed.

The male coupling clamp bracket may be manufactured as a single-piece component that is welded directly onto the seat tube. The single-piece configuration may eliminate the split design when manufacturing processes enable direct attachment to the frame structure. The single-piece bracket may be positioned on the seat tube and welded in place using appropriate welding techniques for the specific materials involved. In some cases, the single-piece bracket may be machined from the same material as the seat tube to ensure material compatibility and optimal joint strength.

Based upon the foregoing disclosure, the present disclosure provides a snap-fit connection system for folding bicycle frames that enables compact storage and transportation through a secure, tool-free folding mechanism. The connection system surpasses conventional folding mechanisms by providing a ball-shaped engagement feature that offers self-centering alignment during assembly while the split configuration creates uniform clamping pressure around the ball's circumference. The cam lever mechanism amplifies applied force to achieve necessary clamping pressure for secure connection while allowing easy release for folding operations, eliminating the need for tools during frame assembly and disassembly.

The cam lever mechanism may be configured with adjustable operational parameters to optimize performance across different applications and user requirements. In some cases, the clamping force applied by the cam lever may be adjusted through different lever ratios to provide varying mechanical advantage. A longer lever arm may provide greater mechanical advantage, allowing users to achieve higher clamping forces with reduced input effort. Conversely, a shorter lever arm may provide more precise control over the applied force while requiring greater input effort from the user.

The cam lever mechanism may incorporate spring-loaded mechanisms to provide consistent pressure throughout the clamping operation. In some cases, a spring element may be positioned within the cam lever assembly to maintain constant tension on the connection components. The spring-loaded mechanism may compensate for minor variations in component dimensions or thermal expansion, ensuring that the clamping force remains within acceptable parameters during operation. The spring element may be a coil spring, leaf spring, or wave spring depending on the specific application requirements.

Torque-limiting features may be integrated into the cam lever mechanism to prevent over-tightening of the connection. In some cases, a torque-limiting mechanism may include a slip clutch or breakaway feature that disengages when a predetermined torque threshold is exceeded. The torque-limiting feature may protect the connection components from damage due to excessive clamping force while ensuring that adequate force is applied to maintain a secure connection. The torque threshold may be calibrated based on the material properties of the connection components and the expected loading conditions.

The engagement angle between the folded and riding positions may be modified from a standard configuration to accommodate different frame geometries or user preferences. In some cases, the connection system may allow for angular adjustment of the folding position through adjustable mounting points or variable geometry components. The engagement angle may be customized to optimize the folded dimensions for specific storage requirements or to accommodate different bicycle frame designs. The angular adjustment capability may provide flexibility in adapting the folding mechanism to various bicycle configurations without requiring significant design modifications.

Additional safety mechanisms may be incorporated to prevent accidental disengagement and provide user feedback regarding connection status. In some cases, secondary locking pins may be positioned to engage with the connection components when the primary cam lever mechanism is secured. The secondary locking pins may provide redundant retention capability, preventing accidental disengagement even if the primary cam lever mechanism becomes loose or fails. The secondary locking pins may be spring-loaded to automatically engage when the connection is properly assembled.

Visual indicators may be integrated into the connection system to show proper engagement status. In some cases, the visual indicators may include colored markers, alignment marks, or position indicators that become visible when the connection is properly engaged. The visual indicators may provide immediate feedback to users regarding the connection status, reducing the likelihood of operating the bicycle with an improperly secured connection. The visual indicators may be implemented through contrasting colors, mechanical flags, or other visual cues that are easily observable during assembly and operation.

Audible click mechanisms may be incorporated to confirm secure connection through acoustic feedback. In some cases, the audible click mechanism may include a spring-loaded detent or snap feature that produces a distinct sound when the connection components reach their fully engaged position. The audible feedback may provide confirmation to users that the connection has been properly assembled, particularly in situations where visual inspection may be difficult or impractical. The click mechanism may be designed to produce a sound that is distinct from other operational noises to ensure clear communication of the engagement status.

Redundant locking systems may incorporate both the cam lever mechanism and auxiliary mechanical locks for applications requiring enhanced security. In some cases, the redundant locking system may include a secondary mechanical lock that operates independently of the primary cam lever mechanism. The auxiliary mechanical lock may include a threaded fastener, pin lock, or other mechanical retention device that provides backup security in the event of primary mechanism failure. The redundant locking system may be particularly beneficial for applications where connection failure could result in safety hazards or equipment damage.

Based upon the foregoing disclosure, the present disclosure provides a snap-fit connection system for folding bicycle frames that enables secure, tool-free operation while maintaining structural integrity during use. The connection system surpasses prior art folding mechanisms by providing adjustable operational parameters, enhanced safety features, and redundant locking capabilities that ensure reliable performance across diverse applications and operating conditions.

A method of folding a bicycle frame may be performed to enable compact storage and transportation of the bicycle. The method may begin by providing a bicycle frame having a front frame, a rear frame, and a seat tube arranged between the front frame and the rear frame. The seat tube may have an upper tube and a lower tube that are selectively rotatable with respect to one another. The upper tube and the lower tube may be connected by a locking coupler having a male coupling with a male ball portion and a female coupling with a female receptacle portion formed by a clamp bracket with a split opening.

The method may include disconnecting a down tube of the front frame from a bottom bracket shell of the rear frame. In some cases, the step of disconnecting the down tube from the bottom bracket shell may comprise removing a locking pin that extends through a frame engagement section of the down tube and a stem of the bottom bracket shell. The locking pin may be a clevis pin that provides a secure yet removable connection between the down tube and the bottom bracket shell. The clevis pin may be withdrawn from aligned holes in the stem and the frame engagement section to release the connection.

The method may further include releasing a cam lever mechanism of the locking coupler to allow the upper tube to rotate relative to the lower tube. In some cases, the step of releasing the cam lever mechanism may comprise rotating a lever arm from a clamped position to a released position. When the lever arm is rotated to the released position, the cam lever mechanism may allow a first opposed clamp bracket portion and a second opposed clamp bracket portion of the clamp bracket to separate. The separation of the clamp bracket portions may permit the male ball portion to disengage from the female receptacle portion by allowing the split opening to widen and reduce the clamping force around the male ball portion.

The method may include rotating the upper tube relative to the lower tube to move the front frame from a first position where the front frame is positioned forwardly of the seat tube to a second position where the front frame is rotated rearwardly of the seat tube. The rotation may be accomplished by grasping the front frame and rotating the upper tube about the lower tube. In some cases, the upper tube may rotate approximately 180 degrees relative to the lower tube to achieve the folded configuration. The male ball portion may remain partially engaged with the female receptacle portion during rotation while the reduced clamping force allows the rotational movement.

The folding method may enable the bicycle frame to be collapsed into a more compact configuration for storage or transportation. The folded bicycle frame may occupy substantially less space than the bicycle frame in the riding position. The method may be reversed to unfold the bicycle frame by rotating the upper tube back to the first position, engaging the cam lever mechanism to secure the locking coupler, and reconnecting the down tube to the bottom bracket shell with the locking pin.

Based upon the foregoing disclosure, the present disclosure provides a folding bicycle frame system that enables significant reduction in storage space and shipping costs while maintaining structural integrity during use. The snap-fit connection mechanism with the ball-shaped engagement and cam lever provides tool-free operation with secure locking that prevents accidental disengagement. The system addresses the fundamental challenges of bicycle transportation and storage by allowing the frame to fold compactly while providing rapid deployment capability for users.

The method of folding the bicycle frame may include disengaging the second male ball portion 606b from the second female receptacle portion 608b through the slip-fit connection. The slip-fit connection may allow smooth disengagement without elastic deformation, facilitating easy separation of the coupling components during the folding process. The bicycle frame folding may reduce storage volume by approximately 50-70% compared to the extended configuration, while the locking coupler 600 provides tool-free assembly and disassembly of the bicycle frame components.

The bicycle frame achieves folding functionality through coordinated operation of multiple interconnected systems that work together to enable rapid transformation between riding and storage configurations. The folding process begins with disconnection of the down tube from the bottom bracket shell, which may be accomplished by removing the locking pin from the connector assembly. This disconnection releases the structural constraint that maintains the front frame in the forward riding position relative to the rear frame.

Following down tube disconnection, the seat tube assembly enables rotational movement between the upper and lower portions through the locking coupler system. The locking coupler may be disengaged by operating the cam lever mechanism, which releases the clamping force that secures the male and female coupling components. When the cam lever is moved to the unlock position, the split configuration of the female coupling allows the opposed clamp bracket portions to separate, creating clearance for the male ball portion to move within the female receptacle portion.

The ball-shaped geometry of the male coupling provides self-centering alignment during both engagement and disengagement operations. As the male ball portion moves within the female receptacle portion during rotation, the spherical surface maintains contact with the female receptacle sides, ensuring proper alignment throughout the rotational range. This self-centering characteristic eliminates the need for precise manual alignment during folding operations and reduces the likelihood of binding or misalignment that could impede smooth operation.

The split configuration of the female coupling creates uniform clamping pressure distribution around the circumference of the male ball portion when the connection is secured. The longitudinal split opening allows the opposed clamp bracket portions to flex outwardly during engagement, accommodating the larger diameter of the male ball portion as the male ball portion passes through the narrower female opening portion. Once the male ball portion reaches the female seated portion, the opposed clamp bracket portions may return to their relaxed position, creating a secure mechanical interface.

The cam lever mechanism amplifies the applied force to achieve secure clamping between the male and female coupling components. The cam lever operates through an eccentric cam surface that engages with a bearing surface as the lever arm is rotated toward the clamped position. The eccentric geometry of the cam creates a mechanical advantage that multiplies the force applied by the user, generating sufficient clamping pressure to eliminate movement between the coupling components. The cam bolt extends through the opposed clamp bracket portions and draws the portions together when the cam lever is actuated, compressing the female receptacle portion around the male ball portion.

During folding operations, the user may first disconnect the down tube from the bottom bracket shell, then operate the cam lever to release the seat tube locking coupler. The front frame may then be rotated rearwardly about the seat tube axis until the front frame is positioned adjacent to the rear frame. The ball-shaped coupling maintains engagement throughout the rotation while allowing the necessary angular movement. To secure the bicycle in the folded configuration, the cam lever may be returned to the locked position, clamping the coupling components and preventing unwanted movement.

Unfolding operations reverse this sequence, with the cam lever being moved to the unlock position to permit rotation of the front frame from the folded position back to the riding position. The self-centering characteristics of the ball-shaped coupling guide the components into proper alignment as the front frame is rotated forward. Once the front frame reaches the riding position, the cam lever may be actuated to secure the seat tube coupling, and the down tube may be reconnected to the bottom bracket shell by inserting the locking pin through the aligned holes in the connector assembly.

The integration of these systems enables tool-free operation while maintaining structural integrity during use. The cam lever mechanism provides sufficient clamping force to prevent movement under riding loads, while the ball-shaped coupling distributes stresses evenly throughout the connection interface. The split configuration allows for manufacturing tolerances while ensuring consistent clamping performance across multiple folding and unfolding cycles.

Based upon the foregoing disclosure, the present disclosure provides a bicycle frame that enables rapid folding and unfolding operations through coordinated mechanical systems. The frame surpasses prior art folding bicycles by providing secure connections that maintain structural integrity during riding while enabling tool-free folding operations. The self-centering ball-shaped coupling eliminates alignment difficulties common in other folding mechanisms, while the cam lever system provides reliable clamping force without requiring tools or complex adjustment procedures. The integrated design reduces the time and effort required for folding operations while maintaining the structural performance necessary for safe bicycle operation.

Based upon the foregoing disclosure, it is seen that the present disclosure provides a snap-fit connection system for folding bicycle frames that offers substantial advantages over conventional bicycle designs and existing folding mechanisms. The connection system enables a significant reduction in shipping costs for manufacturers through the compact folded configuration, which may reduce the overall packaged volume by approximately 50-70% compared to traditional rigid bicycle frames. This reduction in shipping volume translates directly to lower freight costs, reduced storage requirements at distribution centers, and more efficient transportation logistics throughout the supply chain.

The snap-fit connection system may provide improved storage convenience for consumers with limited space, particularly those living in apartments, condominiums, or homes with restricted garage or basement storage areas. The folding capability allows the bicycle to be stored in closets, under beds, or in other compact spaces that would not accommodate a traditional full-size bicycle frame. This storage advantage may make bicycle ownership more accessible to urban dwellers and others facing space constraints.

The connection system may enhance portability for commuters using public transportation or vehicle transport without exterior racks. The folded bicycle configuration enables users to transport their bicycles in car trunks, on trains, buses, or aircraft as regular luggage, eliminating the need for expensive roof racks, hitch-mounted carriers, or oversized luggage fees. This portability advantage may expand the practical applications for bicycle use in multi-modal transportation scenarios and vacation travel.

The tool-free operation of the cam lever mechanism may enable quick folding and unfolding of the bicycle frame without requiring additional tools or complex procedures. The snap-fit engagement allows users to deploy or collapse the bicycle in seconds, making the folding process convenient for daily use. The cam lever provides sufficient mechanical advantage to achieve secure clamping while remaining operable by users of varying physical capabilities.

The secure locking mechanism may prevent accidental disengagement during use through the combination of the ball-shaped engagement geometry and the cam lever clamping force. The ball profile provides self-centering alignment and positive engagement, while the cam lever applies consistent clamping pressure around the ball circumference. This dual-action security system reduces the risk of connection failure during riding, which could result in frame collapse or rider injury.

The connection system may maintain structural integrity and riding performance equivalent to traditional rigid bicycle frames. The ball-and-socket engagement distributes loads evenly across the connection interface, while the cam lever clamping force eliminates movement or flex at the joint. The aluminum construction and reinforcement ribs provide strength characteristics comparable to welded frame joints, ensuring that the folding capability does not compromise the bicycle's structural performance or rider safety.

The snap-fit connection technology may demonstrate broad applicability across various folding frame applications beyond bicycles, including electric scooters, wheelchairs, exercise equipment, strollers, hand trucks, camping furniture, ladders, medical equipment stands, display frames, and utility carts. Each application may benefit from the same core advantages of compact storage, tool-free operation, secure engagement, and reliable structural performance. This versatility may enable manufacturers across multiple industries to incorporate the connection technology into their products, addressing similar challenges related to shipping costs, storage space, and user convenience.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. A bicycle frame comprising:
a front frame having a top tube, a down tube, and a head tube, the top tube being attached to the head tube, and the down tube being positioned below the top tube and further being attached to the head tube;
a rear frame having a pair of spaced-apart seat stays, a pair of spaced-apart chain stays, and a bottom bracket shell, each of the seat stays and the chain stays having a rear end and a front end, the rear ends of the seat stays and the rear ends of the chain stays being connected to a rear drop out, the front end of each chain stay being connected to the bottom bracket shell, and the down tube being releasably connected to the bottom bracket shell;
a seat tube arranged between the front frame and the rear frame and coupled to the front frame and the rear frame, the seat tube having an upper tube and a lower tube, the upper tube and the lower tube being selectively rotatable with respect to one another, the upper tube being connected to the top tube, the lower tube being connected to the front end of the seat stays, and the bottom bracket shell being connected to the lower tube;
a locking coupler for selectively securing the upper tube of the seat tube to the lower tube of the seat tube to thereby restrict rotation therebetween, the locking coupler having a first male coupling and a first female coupling, the first male coupling including a first male ball portion having a spherical geometry, and the first female coupling including a first female receptacle portion configured to receive the first male ball portion, the first female coupling being formed by a clamp bracket that includes a first opposed clamp bracket portion and a second opposed clamp bracket portion, the clamp bracket defining a split opening that extends longitudinally through the clamp bracket, separating the first opposed clamp bracket portion from the second opposed clamp bracket portion; and
a cam lever mechanism operably connected to the clamp bracket and configured to provide clamping force to draw the first opposed clamp bracket portion and the second opposed clamp bracket portion toward one another to secure the first male ball portion within the first female receptacle portion;
wherein the bicycle frame is adapted to be configured in a first position or a second position, in the first position the front frame is positioned forwardly of the seat tube, and in the second position the front frame is rotated rearwardly of the seat tube, wherein the bicycle frame is moved from the first position to the second position by disconnecting the down tube from the bottom bracket shell and rotating the upper tube of the seat tube with respect to the lower tube of the seat tube.

2. The bicycle frame of claim 1, wherein the locking coupler further comprises a second male coupling having a second male ball portion positioned opposite the first male coupling and a second female coupling having a second female receptacle portion configured to receive the second male ball portion.

3. The bicycle frame of claim 2, wherein the first male coupling and first female coupling form a snap-fit connection characterized by elastic deformation of the clamp bracket during engagement, and the second male coupling and second female coupling form a slip-fit connection having complementary straight sidewalls of uniform width.

4. The bicycle frame of claim 1, wherein the first male ball portion includes a male leading portion having a first width and a male seated portion having a second width that is less than the first width, and the first female receptacle portion includes a female opening portion having a first width and a female seated portion having a second width that is greater than the first width.

5. The bicycle frame of claim 1, wherein the cam lever mechanism comprises a lever arm and a cam bolt, the lever arm being rotatable about a pivot axis to provide mechanical advantage for drawing the first opposed clamp bracket portion and the second opposed clamp bracket portion together, and the cam bolt extends through the clamp bracket and is coupled to the lever arm at one end and to an anchoring member at an opposite end.

6. The bicycle frame of claim 1, wherein the clamp bracket includes at least one reinforcement rib extending along an exterior surface of the clamp bracket to provide structural rigidity and prevent deformation under load.

7. The bicycle frame of claim 1, wherein the first male coupling and the first female coupling are manufactured from 7075 aluminum and are secured to the seat tube through adhesive bonding.

8. The bicycle frame of claim 1, wherein the down tube includes a frame engagement section including a transverse hole, and the bottom bracket shell includes a stem having a pair of spaced-apart flanges, each of the flanges having a through hole which is aligned with one another and oriented axially with the transverse hole of the frame engagement section, wherein the down tube and the bottom bracket shell are connected to one another by inserting the frame engagement section between the flanges so that the transverse hole aligns with both of the through holes, and then inserting a clevis pin through the through holes and the transverse hole.

9. A locking coupler for a bicycle frame comprising:
a first male coupling including a first male ball portion having a spherical geometry;
a second male coupling including a second male ball portion positioned opposite the first male coupling;
a first female coupling including a first female receptacle portion configured to receive the first male ball portion, the first female coupling being formed by a clamp bracket that includes a first opposed clamp bracket portion and a second opposed clamp bracket portion, the clamp bracket defining a split opening that extends longitudinally through the clamp bracket, separating the first opposed clamp bracket portion from the second opposed clamp bracket portion, wherein the split opening allows the first opposed clamp bracket portion and the second opposed clamp bracket portion to flex outwardly to accommodate the first male ball portion during engagement;
a second female coupling including a second female receptacle portion configured to receive the second male ball portion; and
a cam lever mechanism operably connected to the clamp bracket and configured to provide clamping force to draw the first opposed clamp bracket portion and the second opposed clamp bracket portion toward one another to secure the first male ball portion within the first female receptacle portion.

10. The locking coupler of claim 9, wherein the first male coupling and first female coupling form a snap-fit connection, and the second male coupling and second female coupling form a slip-fit connection comprising complementary straight sidewalls that provide smooth insertion and removal without elastic deformation.

11. The locking coupler of claim 9, wherein the first male ball portion includes a male leading portion having a first width and a male seated portion having a second width that is less than the first width.

12. The locking coupler of claim 9, wherein the cam lever mechanism comprises a lever arm and a cam bolt, the lever arm being rotatable about a pivot axis to provide mechanical advantage for drawing the first opposed clamp bracket portion and the second opposed clamp bracket portion together.

13. The locking coupler of claim 9, wherein the clamp bracket includes at least one reinforcement rib extending along an exterior surface of the clamp bracket to provide structural rigidity.

14. A method of folding a bicycle frame comprising:
providing a bicycle frame having a front frame, a rear frame, and a seat tube arranged between the front frame and the rear frame, the seat tube having an upper tube and a lower tube that are selectively rotatable with respect to one another, the upper tube and the lower tube being connected by a locking coupler having a first male coupling with a first male ball portion and a first female coupling with a first female receptacle portion formed by a clamp bracket with a split opening;
disconnecting a down tube of the front frame from a bottom bracket shell of the rear frame;
releasing a cam lever mechanism of the locking coupler to allow the upper tube to rotate relative to the lower tube; and
rotating the upper tube relative to the lower tube to move the front frame from a first position where the front frame is positioned forwardly of the seat tube to a second position where the front frame is rotated rearwardly of the seat tube.

15. The method of claim 14, wherein the locking coupler further comprises a second male coupling with a second male ball portion and a second female coupling with a second female receptacle portion, and wherein the method further comprises disengaging the second male ball portion from the second female receptacle portion through a slip-fit connection.

16. The method of claim 14, wherein the step of disconnecting the down tube from the bottom bracket shell comprises removing a clevis pin that extends through a frame engagement section of the down tube and a stem of the bottom bracket shell.

17. The method of claim 14, wherein the step of releasing the cam lever mechanism comprises rotating a lever arm from a clamped position to a released position to allow the first opposed clamp bracket portion and the second opposed clamp bracket portion of the clamp bracket to separate and permit the first male ball portion to disengage from the first female receptacle portion.

18. The method of claim 14, wherein the first male coupling and first female coupling form a snap-fit connection characterized by elastic deformation during engagement.

19. The method of claim 14, wherein the bicycle frame is folded to reduce storage volume by approximately 50-70% compared to an extended configuration.

20. The method of claim 14, wherein the locking coupler provides tool-free assembly and disassembly of the bicycle frame components.
